(19) United States
(12) Patent Application Publication
(10) Pub. No.: US 2025/0266018 A1
(43) Pub. Date: Aug. 21, 2025

(54) Stringed Instrument Pick Sleeve with Loop

(71) Applicant: Russell Jones, Kaysville, UT (US)

(72) Inventor: Russell Jones, Kaysville, UT (US)

(21) Appl. No.: 18/444,210

(22) Filed: Feb. 16, 2024

(51) Int. Cl. G10D 3/173

(52) U.S. Cl. CPC G10D 3/173

(57) ABSTRACT

This invention (“Device”) relates to an accessory for a guitar pick, comprised of a guitar pick sleeve with a loop on one side, designed to enhance the usability of guitar picks by preventing the player from dropping a pick during play. A pick is placed into the sleeve of the Device, and a loop on one side of the Device allows a user to attach a finger, allowing the thumb to rest on the back side of the sleeve, allowing a player to hold the Guitar Pick in a traditional manner. The Loop prevents accidental dropping of the pick, addressing a common issue faced by many guitarists. The Device is crafted from a material that ensures durability and provides comfort to the player, enhancing the overall playing experience. This invention offers a simple, effective solution for improving grip stability, allowing guitarists to optimize their performance without altering grip technique.

### FIELD OF THE INVENTION

This invention relates to the field of musical instruments. More particularly it relates to accessories for stringed instruments that allow a user to have greater control of a Guitar Pick while playing a stringed instrument.

### BACKGROUND

The invention pertains to the field of musical instruments accessories, specifically to improvements in the playability and usability of Guitar Picks for enhanced grip and performance. Guitar Picks, or plectrums, are small flat tools used to strum or pluck the strings of a guitar or other such stringed instrument. The use of Guitar Picks is widespread among guitarists and other stringed instrument musicians due to the control and tonal variations they offer. However, users frequently encounter issues related to grip and comfort, which can affect playability and performance.

Traditional Guitar Picks are typically made from plastic or similar materials and come in various shapes and sizes. Despite this variety, many users find that conventional picks can easily slip between the fingers, especially during prolonged playing sessions or when hands become sweaty. Further, many players suffer from arthritis, which makes it especially difficult to keep a grip on the Guitar Pick. This slipping not only interrupts play but can also lead to poor technique and discomfort. Additionally, the rigid design of most picks does not accommodate the natural contours of the user's fingers, leading to potential strain and fatigue.

Several attempts have been made to address these issues, including textured surfaces, ergonomic shapes, adhesive materials, and attempts to create an apparatus that connects your fingers or thumb to the guitar pick itself. Textured picks aim to provide better grip through raised patterns or coatings, but they often fail to offer significant improvements in comfort or may even lead to increased finger fatigue. Ergonomically shaped picks are designed to fit more naturally between the fingers, yet they do not always cater to the wide variation in user hand sizes and gripping styles. Adhesive materials, while somewhat helpful in preventing slippage, can leave residue on fingers and instruments and may degrade over time, affecting the longevity and cleanliness of the pick, which in turn degrades the quality of the player's experience while using such adhesive materials. Regarding existing pick designs that attempt to attach directly to a user's fingers or thumb—these attempts fall short of fulfilling their stated purpose because the current designs for such picks require the user to hold the pick in an unnatural way, leading to a frustrating playing experience for any such users. Further, because of the complexity of such existing designs, the high cost of making such attachable picks is not ideal for users.

Therefore, there remains a need for an improved, yet simple design that allows a user to hold and grip a guitar pick in a way that effectively creates complete grip security, comfort, and playability without compromising the user's technique and ability to play in comfort. The present invention seeks to overcome the limitations of existing solutions by introducing a novel device that addresses these concerns.

### SUMMARY

The invention allows a guitar or other stringed instrument player to use his or her own existing preferred traditional Guitar Pick, by inserting such Guitar Pick into a specially designed sleeve. Such sleeve has a loop on one side, which allows the user to insert his or her index finger into the loop, and then place the thumb on the opposite side of the sleeve, thus allowing the user to comfortably hold onto the sleeve/Guitar Pick using the same grip that one would normally use to grip a Guitar Pick. This design completely eliminates the risk of accidentally dropping the pick during use, while at the same time providing comfort and the ability to play the stringed instrument in a way that does not alter the user's typical playing technique.

### BRIEF DESCRIPTION OF THE DRAWINGS

FIG. 1 shows an angled view of the top portion of the Device, showing the Loop attached to the Sleeve, and the opening for the insertion of a Guitar Pick.

FIG. 2 shows a view looking directly on the top portion of the Device, showing the Loop attached to the Sleeve. Note that this drawing shows optional grooves on the surface of the Sleeve that may help with grip and comfort for the user.

FIG. 3 shows a profile view of the Device.

FIG. 4 shows the Device laying flat, with the opening of the Device facing forward allowing for the insertion of a Guitar Pick, along with the Loop, which allows a user to insert an index finger therein.

FIG. 5 shows the bottom portion of the Device, and more specifically, the bottom portion of the Sleeve. This portion shows optional grooves on the Sleeve that may be used to enhance the grip and comfort for the user.

FIG. 6 shows an angled view of the bottom portion of the Device, showing an optional smooth surface and the opening for the insertion of a Guitar Pick.

FIG. 7 shows the angled top portion of the Device, with dashed lines representing what it looks like when a Guitar Pick is inserted into the Sleeve.

FIG. 8 shows the bottom portion of the Device while in use.

FIG. 9 shows the top, looped portion of the Device while in use.

### DETAILED DESCRIPTION OF THE INVENTION

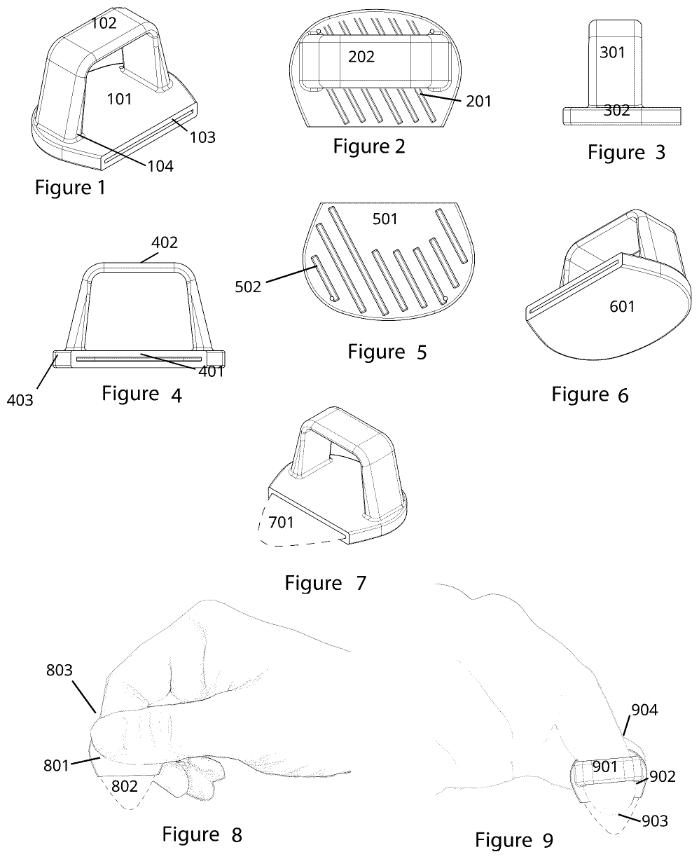

FIG. 1 shows an angled top view of the Device. The Device is mainly comprised of a Sleeve (101) and a Loop (102). A user inserts an index finger into the Loop, allowing the user to hold onto the Device without fear of accidentally dropping the Device. 103 shows the small opening that leads to the hollow portion of the Sleeve, the purpose of which is to insert a Guitar Pick into such opening. The opening herein is just large enough to accept insertion of a traditionally shaped Guitar Pick (triangular shaped with rounded corners and a narrow end coming almost to a point), but small enough to prevent the Guitar Pick from falling out of the opening, unless forcibly removed by the user. The widest portion of the Guitar Pick is to be inserted into the opening, leaving the more narrow end exposed (see 701 for reference), for the purpose of the user striking such narrow end of the Guitar Pick against the strings of a stringed instrument, such as a guitar. 104 shows where the Loop attaches to the Sleeve. Note that the Loop shown in 102 is just one iteration of what the Loop could look like. It may instead be more rounded, or it may have more of an angled shape. Likewise, the Loop can either be permanently or temporarily attached thereto.

FIG. 2 shows the top view of the Device. 202 shows the Loop attached to the Sleeve from the top. 201 shows optional grooves in the surface of the Sleeve. The purpose of the grooves is to aid in the grip and comfort of the user while gripping the Device. In contrast, 101 shows the optional smooth version of the surface of the Sleeve. Note that the grooves depicted in 201 can be of a variety of different shapes or designs—this is just one iteration of what such grooves could look like. Further, in place of the grooves, there could rather exist raised marks or ridges instead of grooves, for the same purpose of providing aid in the grip and/or comfort of the user while using the Device.

FIG. 3 simply shows a profile view of the Device—301 being the Loop, while attached to the Sleeve in 302.

FIG. 4 shows the front view of the Device while laying flat. 401 shows the narrow opening for the purpose of accepted a Guitar Pick into the hollow body of the Sleeve. 402 shows the Loop attached to the Sleeve. 403 shows the Sleeve while laying flat.

FIG. 5 shows the bottom portion of the Sleeve. As can be seen, this bottom portion does not contain a Loop (501). The user instead should place a thumb on this portion of the Sleeve so that he or she may grip the Device in the same manner that such user would typically hold onto a Guitar Pick. Much like in 201, 502 depicts optional grooves that are intended to provide comfort and enhanced grip to the user. These grooves may instead be raised marks or ridges intended for the same purpose, and may also be designed in a variety of different sizes and shapes.

FIG. 6 shows an angled bottom portion of the Device. Specifically, 601 shows the bottom portion of the Sleeve with the optional smooth surface.

FIG. 7 shows an angled top view of the Device, with 701 showing what it looks like when a traditional Guitar Pick is fully inserted into the Sleeve of the Device.

FIG. 8 shows the bottom portion of the Device while in use. One of the major purposes of this Device, as can be seen here in FIG. 8, is that a user can hold onto this Device, with the inserted Guitar Pick, and play a stringed instrument in the same way that a user would normally hold onto a traditional Guitar Pick on its own. This provides the user with a great advantage because the user does not have to change his technique in any way in order to use the Device, while getting the benefit of never accidentally dropping a Guitar Pick while playing. 803 shows the user holding onto the Device in the same way that one would typically hold onto a Guitar Pick. 801 shows the bottom portion of the Sleeve of the Device (the portion that does not have the Loop). 802 shows where a traditional Guitar Pick is located when fully inserted into the Sleeve of the Device.

FIG. 9 shows the top portion of the Device while in use. 904 shows the user holding onto the device in the same manner that one would typically hold onto a traditional guitar pick. 901 shows the Loop attached to the Sleeve of the Device, and 902 shows the top portion of the Sleeve of the Device. 903 shows what it looks like when a traditional Guitar Pick is fully inserted into the Sleeve of the Device.

In the iteration of the Device as shown herein, the Loop is permanently attached to the Sleeve of the Device, and thus the Device is made of only one piece. In other possible iterations of the Device, the Loop may be temporarily attached to the Sleeve. Such temporary attachment may be accomplished by using velcro, a sticky substance, a snap locking system, or another similar system to attach the Loop to the Sleeve. Likewise, in the iteration of the Device as shown herein, the Loop cannot be adjusted. However, in other iterations of the Device, the Loop may be adjusted to account for different finger sizes and user preferences, which may be accomplished by cutting the loop to size and then attaching it back to the Sleeve using velcro or another sticky substance, or by using a clasp or another locking mechanism to adjust the Loop.

A separate, and previously existing traditional Guitar Pick is necessary for the Device to be of use, and such Guitar Pick is to be inserted into the Sleeve of the Device for the user to gain the benefit of the Device. Once a Guitar Pick has been inserted into the Sleeve of the Device, the opening is tight enough that it will not simply fall out. However, a user may forcibly remove the Guitar Pick from the Sleeve of the Device if such user desires to either swap out the Guitar Pick for a new one, or if the user simply desires to play with such Guitar Pick by itself without the assistance of the Device.

The Device itself is to be made of a strong and durable, and yet somewhat flexible material, such as silicone, a soft and pliable plastic, or rubber. The Device may be made using injection molding to ensure the Device is strong and durable, and yet somewhat flexible.

Note that the prior art in this field that aim to achieve similar results to this Device are all either lacking, or else aim to achieve similar, but yet materially different results. For example, many previous inventions or pick grip products aim only to make it less likely that a user could accidentally drop a Guitar Pick. Whereas this Device makes it impossible for a user to accidentally drop a Guitar Pick due to the innovate Loop design.

Other prior inventions have some type of apparatus meant to attach to a user's fingers or thumb to a guitar pick, but these inventions a) involve contraptions to attach the user's fingers or thumb directly to the guitar pick, and b) provide for an awkward user experience once such fingers or thumb is attached to the guitar pick because the user must then alter the way her or she would normally grip a guitar pick, leading to a frustrating experience for the user and leading to a necessarily altered playing technique. In contrast, the attachment mechanism of the present Device uses a Loop that connects the user's finger to a sleeve rather than connecting the user's finger to a guitar pick itself. Further the design of the present Device allows a user to comfortably hold onto, and grip the Device in the same manner that one would typically use to hold onto a guitar pick, leading to a pleasant, and enhanced experience of playing the stringed instrument without the worry of accidentally dropping the Guitar Pick.

Further, other superficially similar inventions exist that allow a user to “finger pick” or “thumb pick” the strings of a guitar using devices that attach modified guitar picks to a user's fingers or thumb. However, the present Device is not meant to aid a user in finger picking or thumb picking the strings of a guitar, but rather it is intended to aid a user in playing a stringed instrument in the exact way that one would normally use a traditional guitar pick to play the guitar, but with the added benefit of no longer having the possibility of accidentally dropping the guitar pick while playing.

1. An accessory to a Guitar Pick (the “Device”) that is separate from, but intended to be used in conjunction with a Guitar Pick, wherein such Device comprises:
a sleeve (the “Sleeve”) with a hollow body containing an opening on one end of the Device, and such opening is large enough to accept the insertion of a Guitar Pick through such opening, but small enough to prevent the Guitar Pick from falling out of the Device once it has been inserted into the opening; wherein the sleeve only covers the widest portion of the Guitar Pick, allowing the user of the Device to strike the open end (being the narrow end of the Guitar Pick that tapers down and almost comes to a point) of the inserted Guitar Pick against the strings of a stringed instrument; and
on the top portion of the Sleeve exists an attached loop (the “Loop”) that allows the user to insert an index finger into such Loop for the purpose of being able to keep such user's finger attached to the Device; wherein the user's finger is inserted into the Loop in such a way as to allow the user's thumb to easily be placed on the back of the Sleeve, allowing such user to hold the Device in the same manner that such user would typically hold a Guitar Pick.

2. The Device of claim 1, wherein either the bottom portion of the Sleeve, or the top portion of the Sleeve, or both the top and bottom portions of the Sleeve, have raised marks or lowered grooves on such portions of the surface of the Sleeve, for the purpose of enhancing the user's grip on the Device.

3. The Device of claim 1, wherein the top and bottom portions of the Sleeve both have a smooth surface.

4. The Device of claim 1, wherein the Loop can be temporarily attached or temporarily removed from the Sleeve.

5. The Device of claim 1, wherein the Loop is permanently attached to the Sleeve.

6. The Device of claim 1, wherein the Loop is adjustable.

7. The Device of claim 1, wherein the Loop is not adjustable.
